(19) United States
(12) Patent Application Publication
(10) Pub. No.: US 2002/0133616 A1
(43) Pub. Date: Sep. 19, 2002

(54) Method and apparatus for using a known address to gain access to a service provider having an unknown address

(76) Inventors: Richard Yoza, San Jose, CA (US); Roopak Parikh, San Jose, CA (US); Prakash Iyer, San Jose, CA (US)

Correspondence Address: Pillsbury Winthrop LLP, Intellectual Property Group, Ninth Floor, East Tower, 1100 New York Avenue, N.W., Washington, DC, 20005-3918, US

(21) Appl. No.: 09/765,076

(22) Filed: Jan. 17, 2001

(51) Int. Cl. G06F 15/173

(52) U.S. Cl. 709/238; 709/225

(57) ABSTRACT

A method for providing service to a communications device that has contacted a service provider that is unable to provide service directly. The method includes examining a service request from a communications device at a first service provider having a first address to determine whether the communications device is to be redirected to a second service provider having a second address, and sending to the communications device from the first service provider the second address when the communications device is to be redirected to the second service provider.

### FIELD

This invention relates to obtaining a service using a communication device, and more specifically, to obtaining service from a service provider whose address is unknown by using the address of a known service provider.

### BACKGROUND

Increasingly, wireless communications devices such as cellular phones, personal digital assistants, handheld computers provide or are being required to provide services offered by internet based websites. Examples of services include, but are not limited to, stock trading, buying or selling goods, sports information, and the weather. The websites that provide services to wireless devices use a language, such as wireless markup language (WML) or handheld device markup language (HDML), that is typically different from the language used by websites that communicate with laptop or desktop computers. Unlike laptop or desktop computers, which have the processing power and high data rates that can typically support a browser that uses the resource demanding hypertext markup language (HTML), wireless devices often have weaker capabilities and lower data rates that support browsers (micro-browsers) that uses less demanding languages such as WML and HDML. Consequently, wireless devices often are unable to communicate with the HTML websites. One way to provide the services offered by a HTML website to wireless devices is to create a mirror website which communicates using WML or HDML documents. The HDML or WML website or any website that communicates with limited resource or ‘thin’ communications device is referred to herein as a ‘reduced content’ website. The HTML website is referred to herein as a ‘full-content’ website.

Since each website has to have a unique address or uniform resource locator, the HTML website and the reduced content website have different addresses. Unlike a mirror website, however, the HTML website is typically be far better known, partly because it may have been around longer and become familiar to many more people than a recently developed mirror website.

Having two websites with two different addresses poses at least two problems. Firstly, to attract users to the mirror website (i.e., develop address or name recognition) significant money and effort may have to be expended. Secondly, having two separate websites results in a user having to memorize or be able to identify two different addresses. As the number of websites with which a user interacts increases, the burden on the user may become quite significant.

Having to spend money and effort to develop address recognition for the mirror website and requiring a user to memorize or identify twice as many addresses as the user previously had to know is undesirable. Consequently, it is desirable to provide a mechanism for allowing a communications device arrive at the reduced content website after the user has supplied the address of the full content website to the communications device.

### SUMMARY

A method for providing service to a communications device that has contacted a service provider that is unable to provide service directly is described. The method includes examining a service request from a communications device at a first service provider having a first address to determine whether the communications device is to be redirected to a second service provider having a second address, and sending the second address to the communications device from the first service provider when the communications device is to be redirected to the second service provider.

### DESCRIPTION OF THE DRAWINGS

The invention will be better understood by reference to the following detailed description and the accompanying drawings:

FIG. 1 illustrates a block diagram of a system in which wireless and wired devices communicate with an application server;

FIG. 2 illustrates a process for providing service to a communications device that has contacted a server that is unable to provide service directly;

FIG. 3 illustrates an alternative process for providing service to a communications device that has contacted a service provider that is unable to provide service directly; and

FIG. 4 illustrates a block diagram of a server according to one embodiment of the present invention.

### DETAILED DESCRIPTION

Methods and apparatus for providing service to a communications device that has initially contacted a service provider that is unable to provide service directly are described. In the following description, for purposes of explanation, numerous specific details are set forth in order to provide a thorough understanding of the present invention. It will be evident, however, to one skilled in the art that the present invention may be practiced in a variety of communication systems, especially wireless application protocol systems, and communications devices, especially telephones, without these specific details. In other instances, well-known operations, steps, functions and devices are not shown in order to avoid obscuring the invention.

Parts of the description will be presented using terminology commonly employed by those skilled in the art to convey the substance of their work to others skilled in the art, such protocol, gateway, render, store, interpret, and so forth. Also parts of the description will also be presented in terms of operations performed through the execution of programming instructions or initiating the functionality of some electrical component(s) or circuitry, using terms such as, performing, sending, processing, transmitting, configuring, and so on. As well understood by those skilled in the art, these operations take the form of electrical or magnetic or optical signals capable of being stored, transferred, combined, and otherwise manipulated through electrical or electromechanical components.

Various operations will be described as multiple discrete steps performed in turn in a manner that is most helpful in understanding the present invention. However, the order of description should not be construed as to imply that these operations are necessarily performed in the order that they are presented, or even order dependent. Lastly, repeated usage of the phrases “in one embodiment,” “an alternative embodiment,” or an “alternate embodiment” does not necessarily refer to the same embodiment, although it may.

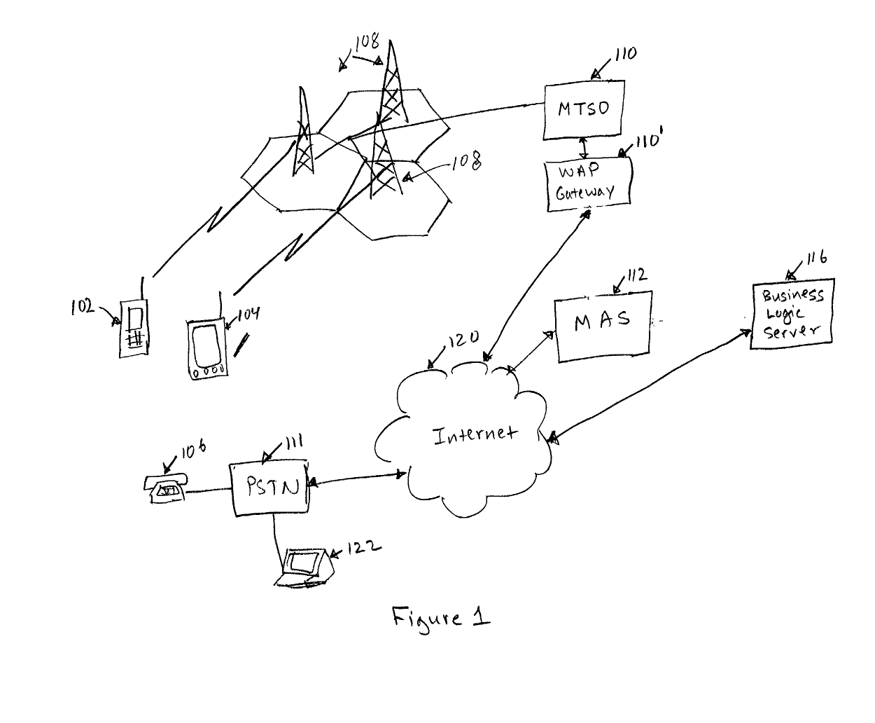

FIG. 1 illustrates a block diagram of a system in which wireless and wired devices communicate with an application server. System 100 includes telephone 102, personal digital assistant (PDA) 104, telephone 106, cellular stations 108, mobile telephone switching office 110, public switched telephone network switching office 111, mobile application server 112, storage 114, business logic server 116, web server 118, internet 120, and computer 122. Business logic server 116 is the host for a website with an address or uniform resource locator that is widely known. It is not unusual for a popular website to have millions of users, if not tens of millions. For purposes of illustration, the website has the following address: www.services.com. The website provides in various embodiments services including, but not limited to, retrieving stock quotes and airline flight information or sport scores, trading stock, buying and selling goods. Since the services are provided using hypertext markup language (HTML) documents or pages, the website is referred to as a ‘full content’ website. These services can be procured directly from server 116 using computer 122 because computer 122 has sufficiently high processing power, a large display, and high communications data rate to support a web browser that is capable of executing HTML code.

Telephone 102 and PDA 104, on the other hand, typically have relatively low processing power, small displays, and a low communications data rate. Consequently, they are unable to support a browser that executes HTML code. In one embodiment, telephone 102 and PDA 104 have a browser that is capable of executing wireless markup language (WML) or handheld markup language (HDML) code, which require relatively less processing power and communications data rate, and are better suited for the small displays of telephone 102 and PDA 104. Telephone 102 and PDA 104 are referred to herein as ‘reduced content’ devices because their browsers use WML and HDML to render less graphically intensive displays. WML and HDML are referred to herein as reduced content languages.

The remaining description below is provided in the context of telephone 102 procuring service. It should be appreciated that the description is equally applicable to PDA 104, a handheld computer, or other communications devices that have user input and output interfaces and the ability to communicate with a wireless network.

The nature of the services provided by the full content website are such that they are desired by mobile users of telephone 102. Moreover, the operator of the full content website would like to service mobile users without having to change significantly the full content website. Since the full content website is typically not going to be modified and since the full content website communicates in HTML code, a user of telephone 102 cannot directly access the services of the full content website.

However, a user of telephone 102 can indirectly access the services of the full content website by using a reduced content website on server 112. Server 112 hosts a reduced content website that can take HTML documents from server 116 and reformat or represent them in a different manner so that they can be rendered on reduced content devices. Mechanisms for extracting data from an HTML document and representing it in a manner suitable for reduced content devices is the subject of co-pending patent application “Method for Converting Two-dimensional Data into a Canonical Representation” with Ser. No. 09/394,120, filed on Sep. 10, 1999, and co-pending patent application “Method for Customizing and Rendering of Selected Data Fields” with Ser. No. 09/393,133, filed on Sep. 10, 1999.

For purposes of illustration, the reduced content website has the following address or URL: www.services.everpath.com. The reduced content website has a script for each page or document of the full content website. The script defines what is extracted from an HTML page and how it is to be presented on a reduced content device. Using the script, server 112 takes an HTML document and generates a page or pages in a language understood by a reduced content device. In one embodiment, server 112 generates WML or HDML documents. Additionally, server 112 can generate audible voice information that can be heard using telephone 102.

For example, assume a user of telephone 102 or PDA 104 contacted server 112 and is requesting access to www.services.everypath.com—the details of making such a connection will be described below. Server 112 recognizes from the request that telephone 102 is attempting to get to the home page of www.services.com. Consequently, server 112 requests the home page from server 116. Using the script and the home page received from server 116, server 112 creates a reduced content page or pages that can be rendered by telephone 102. The reduced content pages are sent to telephone 102 by way of MTSO 110 and cellular stations 108.

In one embodiment, the home page has fields for user identification and password that a user needs to fill in before submitting the page to server 112. The user can enter the information using the keypad (not shown) of telephone 102. After filling in the information requested by the home page, the user submits the page to server 112. Server 112 extracts the information filled in by the user and submits the information back to server 116. Server 116 replies back with a user login page, www.services.com/loginuser. Using a script associated with the user login page, server 112 represents the page in a manner understood by the browser of telephone 102.

In an alternative embodiment, the home page is rendered through text-to-voice technology that presents audible choices to a user of telephone 102. A user responds to server 112 by pressing a key to generate a dual tone multi-frequency (DTMF) tone or speaking into the telephone's microphone.

In the manner described above, according to one embodiment, a user of a non-HTML communications device such as telephone 102 is able to procure the services of an HTML based website on server 116.

In the above illustration, to access the services of the full content website on server 116, a user of telephone 102 had to know the address of the reduced content website on server 112. If the user does not know the address of the reduced content website, the user is not going to be able to access the services of server 116. Since the website on server 116 has a well-known address that a user of telephone 102 knows, it is desirable to allow a user who can provide the address of the full content website to the communications device to get access to the services of server 116 as represented by server 112. The present invention provides several mechanisms for achieving this goal. The mechanisms do not require the expenditure of effort and money to make users of reduced content devices aware of the address of the reduced content website.

Before describing the various mechanisms, the operation of system 100 will be described. In one embodiment, telephone 102 and PDA 104 communicate in accordance with wireless access protocol (WAP). WAP is an application environment and a group of protocols that define access of wireless devices to internet services. The application environment is uniform and does not depend on the underlying protocol for the communications air link. WAP is implemented or will be implemented on global system for mobile communications (GSM), interim standard (IS)-136, time-division multiple access (TDMA), personal communications service (PCS), and code division multiple access (CDMA), among other schemes. The present invention can be practiced with any application environment and communications protocols.

A WAP request from telephone 102 can be a URL request such as http://www.services.everypath.com. Telephone 102 converts the text URL into a binary wireless session protocol (WSP) request. WSP is a protocol layer that defines efficient exchange of data between applications. Depending on the particular embodiment, the binary request is transmitted to cellular station 108 in accordance with one of the air link protocols indicated above. Station 108 forwards the binary request to MTSO 110. MTSO provides a connection to the public switched telephone network for mobile phones making telephone calls. MTSO 110 also includes gateway 110′ which is an interface between the wireless network and internet 120. Gateway 110′ converts the binary request to an HTTP request and sends the request to server 112 via internet 120.

As described above, server 112 recognizes that the request is for the login page at www.services.com. Thus, server 112 requests that server 116 send it the HTML document associated with the login page. Using a script associated with the login page, server 112 generates a text WML page (or pages) and sends it to gateway 110′. It should be appreciated that server 112 can generate a page in a language, other than WML, that is understood by the reduced content device, such as HDML. Gateway 110′ converts the text WML page into binary WML. Gateway 110′ sends the binary WML page using WSP protocol to MTSO 110 which forwards it to station 108. Station 108 transmits the binary WML page to telephone 102. Telephone 102 converts the binary WML page into a text WML page. The browser interprets or executes the text WML page to render a screen of information on the display of telephone 102.

In the above description, a user of telephone 102 accesses the services of the full content website on server 116 by connecting to the reduced content website on server 112. If the user does not know the address of the reduced content website, the user will be unable to procure the services of the full content website. The description below in conjunction with the description above illustrates three mechanisms for allowing a user to procure the services of the full content website even though the user does not know the address of the reduced content website.

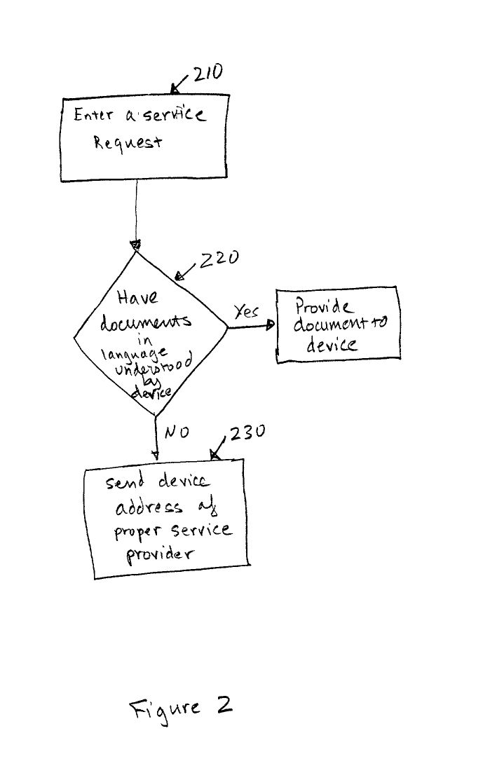

FIG. 2 illustrates a process for providing service to a communications device that has contacted a server that is unable to provide service directly. In process 200, a reduced content device such as telephone 102 attempts to procure service from the full content website on server 116. As indicated above, the address of the full content website is www.services.com. In process 200, a user enters 210 or selects at telephone 102 the uniform resource locator www.services.com. Telephone 102 converts the text URL to a binary wireless session protocol (WSP) request and sends the request to gateway 110′ in MTSO 110 by way of stations 108. Gateway 110′ converts the WSP request to an HTTP request and sends the HTTP request via internet 120 to server 116. Server 116 examines 220 the HTTP request to determine whether it is able to supply telephone 102 the information it is requesting (home page for the website) in a language understood by telephone 102. An HTTP request includes a header that has a field that specifies the languages accepted by telephone 102. The following is an example of a header for a telephone provided by Sprint PCS:

GET / HTTP/1.0
x-up-uplink: up2.upl.sprintpcs.com
x-up-fax-accepts: none
x-up-fax-limit: 0
User-Agent: UP.Browser/3.01-IG01 UP.Link/3.2.1.4
x-up-devcap-softkeysize: 5
x-up-devcap-iscolor: 0
x-up-devcap-charset: US-ASCII
Accept: application/x-hdmlc, application/x-up-alert, application/x-up-cacheop,
application/x-up-device, application/x-up-digestentry, , text/x-hdml;version=3.0, text/x-
hdml;version=2.0,
text/html,text/x-wap.wml,text/vnd.wap.wml, */*
x-up-devcap-screenchars: 24,9
x-up-devcap-screenpixels: 120,127
x-up-devcap-screendepth: 1
x-up-devcap-max-pdu: 05d4
Accept-Charset: US-ASCII, UTF-8, *
Accept-Encoding: 7bit, 8bit, binary
x-up-subno: 4088293010_up2.upl.sprintpcs.com
Accept-Language: en-us
x-up-devcap-numsoftkeys: 2
x-up-devcap-smartdialing: 0
Connection: Keep-Alive
Host: 216.233.67.211

The header includes an accept field which specifies that telephone 102 accepts documents in accordance with HDML. Since server 116 communicates using HTML instead of HDML or WML, server 116 cannot provide to telephone 102 the content associated with the URL in a language understood by telephone 102. Consequently, server 116 replies 230 to telephone 102 that it should redirect its requests for service to server 112 by sending telephone 102 the URL for the website providing the service on server 112, www.services.everypath.com. The URL for the reduced content website is provided in the status code of the HTTP reply. For example, the HTTP reply could be as follows:

HTTP/1.0 301 Moved Permanently
Date: Fri, 31 Dec 1999 23:59:59 GMT
Location: http://www.services.everypath.com

Having server 116 redirect telephone 102 to server 112 is referred to herein as redirection. Telephone 102 then converts the URL received from server 116 into a binary WSP request and sends the binary WSP request to gateway 110′ by way of stations 208. Gateway 110′ converts the WSP request to an HTTP request and sends the HTTP request via internet 120 to server 112. In this manner, telephone 102 is able to connect to the reduced content website on server 112. As described above, server 112 retrieves the appropriate pages from server 116 and represents them in the manner appropriate for telephone 102 so that a user of telephone 102 may procure the services provided by the full content website on server 116.

While in one embodiment server 116 examines the languages accepted field of a header to determine whether it should redirect a request from telephone 102, it should be appreciated that in alternative embodiments other parts of the header can be examined. For example, the user-agent field can be used instead.

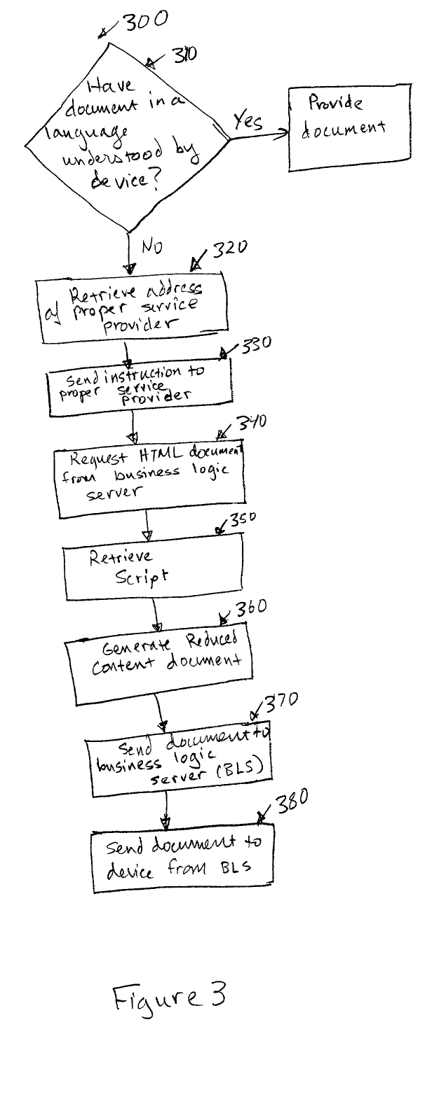

FIG. 3 illustrates an alternative process for providing service to a communications device that has contacted a service provider that is unable to provide service directly. In process 300, server 116 determines 310 whether, for the URL received from telephone 102, it has a corresponding document that is composed in a manner understood by telephone 102. If server 116 does not have the document composed in a manner understood by telephone 102, server 116 retrieves 320 from memory, based on the URL, the address of a website that has the document composed in a manner understood by telephone 102. Since the reduced content website on server 112 has the information composed in a manner understood by telephone 102, server 116 retrieves the URL for the reduced content website, www.services.everypath.com. Server 116 sends 330 an instruction, including www.services.everypath.com, to server 112 to generate a document in a manner understood by telephone 102 and to send the generated document to server 116. Server 112 receives the instruction and based on the URL in the instruction it retrieves 340 from server 116 the HTML document that is associated with www.services.com). Additionally, server 112 retrieves 350 from memory the script that is associated with www.services.com. Using the script and the retrieved HTML document, server 112 generates 360 a WML page and sends 370 the WML page server 116. Server 116 forwards 380 the WML page to telephone 102.

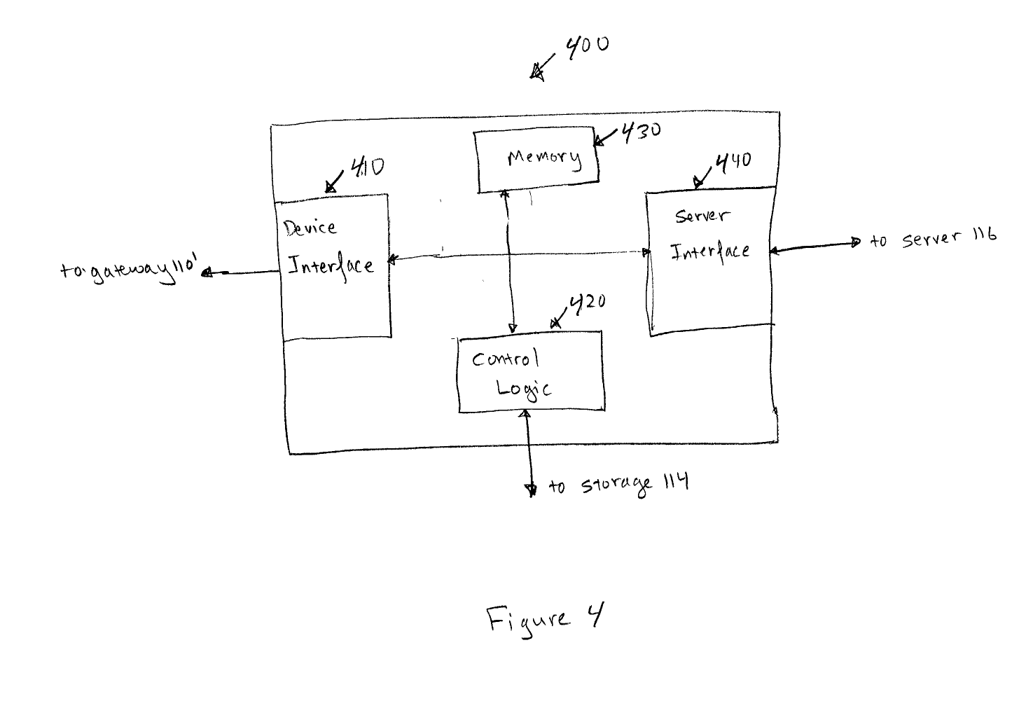

FIG. 4 illustrates a block diagram of a server according to one embodiment of the present invention. Server 400 is representative of server 116 of FIG. 1. In one embodiment, server 400 includes device interface 410 that is to receive an HTTP request from gateway 110′. The HTTP request sent from gateway 110′ is based on a WAP request that gateway 110′ received from telephone 102. The HTTP request is for www.services.com. Since telephone 102 is a reduced content device, either the languages accepted or the user-agent fields indicate that telephone 102 cannot process HTML. Control logic 420 examines either of these fields and determines that telephone 102 should not be sent HTML documents. Furthermore, logic 420 takes the URL it receives in the HTTP request and looks up in memory 430 based on the URL the website that should be communicating with telephone 102. Memory 430 stores a look up table that has www.services.everypath.com associated with www.services.com. Control logic 420 replies back to telephone 102 as follows:

HTTP/1.0 301 Moved Permanently

Date: Fri, Dec. 31, 1999 23:59:59 GMT

Location: http//www.services.everypath.com

In this manner, telephone 102 is redirected to www.services.everypath.com on server 112. In the embodiment just described, server 400 operates in accordance with process 200 described above in connection with FIG. 2.

In an alternative embodiment, device interface 410 receives an HTTP request from gateway 110′. The HTTP request corresponds to a WAP request sent from telephone 102 to gateway 110′. The HTTP request is for www.services.com. Since telephone 102 is a reduced content device, either the languages accepted or the user-agent fields indicate that telephone 102 cannot process HTML. Control logic 420 examines either of these fields and determines that telephone 102 should not be sent HTML documents. Furthermore, logic 420 takes the URL it receives in the HTTP request and looks up in memory 430 based on the URL the website that can generate documents in a language understood by telephone 102. Memory 430 stores a look up table that has www.services.everypath.com associated with www.services.com. Since www.services.everypath.com is located on server 112, control logic 420 sends an HTTP request to server 112 to retrieve a reduced content language document associated with www.services.com. Server interface 440 communicates with server 112 to retrieve the reduced content language document for control logic 420. Control logic 420 then sends the reduced content language document to telephone 102 using device interface 410. In the embodiment just described, server 300 operates in accordance with process 300 described above in connection with FIG. 3.

Thus, methods and apparatus for providing service to a communications device that has contacted a service provider that is unable to provide service directly have been described. Although the present invention has been described with reference to specific exemplary embodiments, it will be evident to one of ordinary skill in the art that various modifications and changes may be made to these embodiments without departing from the broader spirit and scope of the invention as set forth in the claims. Accordingly, the specification and drawings are to be regarded in an illustrative rather than a restrictive sense.

We claim:

1. A method for providing service to a communications device that has contacted a service provider that is unable to provide service directly:
examining a service request from a communications device at a first service provider having a first address to determine whether the communications device is to be redirected to a second service provider having a second address in the event the communications device and the second provider are not compatible; and
sending to the communications device from the first service provider the second address when the communications device is to be redirected to the second service provider.

2. The method of claim 1, further comprising sending from the communications device to the first service provider the service request based on the first address.

3. The method of claim 1, further comprising:
sending a second service request from the communications device to the second service provider; and
wherein the service request is based on the second address received from the first service provider.

4. The method of claim 1, wherein examining includes examining type of language supported by the communications device.

5. The method of claim 1, wherein compatible is ability to communicate using a language common to both the first service provider and the communications device.

6. The method of claim 5, wherein the first provider communicates in HTML and the communications device communicates in WML.

7. A method for providing service to a communications device that has contacted a service provider that is unable to provide service directly, the method comprising:
examining a service request from a communications device at a first service provider having a first address to determine whether the first service provider is unable to provide service in a manner understood by the communications device;
retrieving from a second service provider having a second address information that is understood by the communications device when the first service provider is unable to provide service in a manner understood by the communications device; and
sending to the communications device from the first service provider the information.

8. The method of claim 7, wherein examining includes examining type of language supported by the communications device.

9. A server having a first address, the server comprising:
storage that stores a second address for a second service provider;
a device interface that is to receive a service request from a communications device; and
control logic that is to examine the service request; and
wherein the control logic is to send the second address to the communications device when the communications device is to be redirected to the second service provider.

10. A server having a first address, the server comprising:
storage that stores a second address for a second service provider;
a device interface that is to receive a service request from a communications device; and
control logic that is to examine the service request to determine whether the server has information composed in a manner understood by the device; and
wherein, when the server does not have the information composed in a manner understood by the device, the control logic is to retrieve from a second service provider based on the second address the information and to send the information to the communications device.
